(19) United States
(12) Patent Application Publication
(10) Pub. No.: US 2009/0086167 A1
(43) Pub. Date: Apr. 2, 2009

(54) PROJECTION TYPE IMAGE DISPLAYING APPARATUS

(76) Inventors: Masahiko Yatsu, Fujisawa (JP); Koji Hirata, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/166,354

(22) Filed: Jul. 2, 2008

(30) Foreign Application Priority Data
Sep. 28, 2007 (JP) 2007-253038

(51) Int. Cl. G03B 21/14

(52) U.S. Cl. 353/20

(57) ABSTRACT

A projection type image displaying apparatus, comprises a light source unit, an illumination optic system including a color separation means therein, a plural number of image display elements, a cross prism, which is configured to function as a color composing means; and a projection optic system, in which an incidence angle onto an image surface is equal to 55 degree or greater than that, and further comprises a structure, which is configured to dispose the projection type image displaying apparatus standing vertically, so as to enable it to display an image on a horizontal surface, wherein a polarized light converting means is provided between the cross prism and the projection optic system, or within the projection optic system, so as to bringing polarization conditions on the image surface for color lights to be substantially equal to one another, by the polarized light converting means, thereby providing the projection type image displaying apparatus of generating no color shading even when projecting an image light, having a large incidence angle to the image surface, onto a horizontal plane or surface.

### BACKGROUND OF THE INVENTION

The present invention relates to a technology for providing a projection apparatus, projecting an image on a screen, with using an image display element, applying a liquid crystal therein.

In cross prism to be used as a color composing or synthesizing means, there may be generated a color shading or discoloring due to difference in the reflectivity (or transmissivity) thereupon, between the P polarized light and S polarized light, and countermeasures for that are disclosed in the following Patent Documents 1 and 2. Also, regarding a projection optic system, description is made in the following Patent Document 3, in relation to an incidence angle onto an image surface.

[Patent Document 1] Japanese Patent Laying-Open No. 2005-321544 (2005);

[Patent Document 2] Japanese Patent Laying-Open No. 2004-133112 (2004); and

[Patent Document 3] Japanese Patent Laying-Open No. 2006-292901 (2006).

### BRIEF SUMMARY OF THE INVENTION

Upon the cross prism, being the color composing means, can be incident the P polarized light, as a transmission light, while the S polarized light, as a reflection light, thereby conducting the color composing. First of all, explanation will be made on a reason of this, by referring to FIGS. 11 and 12 attached herewith. FIG. 10 is a view for showing the reflectivity in case where the P polarized light and the S polarized light are incident upon, respectively, from an air into a transparent medium, at a certain angle. With using an incidence angle α in the air, and a refraction angel β in the medium (refractive index=N), the reflectivity of the P polarized light and the reflectivity of the S polarized light can be determined by the following (Eq. 1)

R_{S}={ sin(α−β)/sin(α+β)}²

R_{P}={ tan(α−β)/tan(α+β)}² (Eq. 1)

The S polarized light is large in the reflectivity, comparing to the P polarized light, and as a result of calculation in FIG. 10 where assuming that the refractive index of the medium is 1.5, the P polarized light has the reflectivity being almost 0% at the incidence angle of about 55 degree. The angle where the reflectivity of the P polarized light comes to be 0% is that, which is called by “Brewster Angle”. Regarding this Brewster Angle, disposing a plate at a predetermined angle to a natural light enables reflection thereupon of only the S polarized light while passing all the P polarized light therethrough. However, when the incidence angle α is zero (α=0), there is no difference between the polarized lights, and then the reflectivity={(N−1)·(N+1)}²=4%.

Next, referring to FIG. 12, explanation will be made on the positional relationship between a projection optic system having a free-curved surface mirror, as a projection system mirror, and the cross prism. However, an example of the projection optic system having such the free-curved surface mirror therein is disclosed in the Patent Document 3 mentioned above. In FIG. 12, a red color light emitted from the image display element 2R, a green color light emitted from the image display element 2G, and a blue color light emitted from the image display element 2B are color-composed by means of a cross prism 3 including dichroic films in a cross-like (+) manner. The red color light, the green color light and the blue color light that are color composed, after being affected with a refraction effect on a refraction system lens 11 and a reflection effect on the free-curved surface mirror, as a projection system mirror 12, are projected on an image surface 30.

Herein, the cross prism 3 for composing the three (3) color lights has a function or effect of transmission for one (1) color light, and a function or effect of reflection for the remaining two (2) color lights. Accordingly, it can be seen that the color composition should be conducted on the red color S polarized light, the green color P light, and blue color S polarized light, when applying the result shown in FIG. 11 into the positions of the image display elements 2R, 2G and 2B.

With this cross prism 3, a normal line of the cross-like dichroic surface lies on XZ plane, but on the contrary thereto, normal lines of the projection system mirror 12 and the image surface 30 are on YZ plane. Accordingly, the red color and blue color lights of S polarization, which were the S polarized lights on the cross prism, become the P polarized lights on the projection system mirror 12 and the image surface 30, on the contrary the green color light, which was the P polarized light on the cross prism, becomes the S polarized light on the on the projection system mirror 12 and the image surface 30.

In the Patent Document 1, while pointing out the fact that the cooler shading or discoloring is generated upon combination of the polarizing character inherent to a transmission type screen (i.e., of a Fresnel lens) and the polarization condition of the incident light, there is disclosed a method for improving the color shading, obtaining pseudo non-polarizing condition by disposing a phase plate of 5000 nm in the phase difference.

In FIGS. 1 and 2 of the Patent Document 2, while pointing out the fact that the difference in the reflectivity is about 17% at the wavelength 550 nm upon a half mirror disposed at 45 degree, which is used in a prompter (an observation apparatus) (=about 22% of S polarized light−about 5% of S polarized light), and therefore generating the color shading, it is disclosed that an improvement can be achieved on the color shading by disposing a wavelength plate. Also, in FIGS. 4 and 5 of the Patent Document 2, describing that the color shading is generated on six (6) surfaces, in total, of the reflection surfaces, even in the case of applying the free curved surface mirror in the projection optic system, in spite of that the difference in the reflectivity is about 2% per one (1) surface (=S polarized light reflectivity of about 99.5%−P polarized light reflectivity of about 97.5%), and in the similar manner to the above, it is disclosed that an improvement can be achieved by disposing the wavelength plate. Herein, calculating out the difference in reflectivity upon among the six (6) surfaces, in total, in more details thereof, 0.995⁶−0.975⁶=0.111, i.e., it can be said that the color shading is generated with the difference of 11%.

On the other hand, as the projection optic system being short in projection distance so as to obtain an ultra-wide angle, in the Patent Document 3 is disclosed a projection optic system, for example, of an oblique projection method of obliquely projecting an image upon the image surface. On the light ray drawing shown in FIG. 11 of the Patent Document 3, the maximum value of the incidence angle can be read about 56 degree. This value is the incidence angle at an upper end on the rectangular display area or region of the image surface, therefore the incidence angle at the diagonal portion on the rectangular display area of the image surface comes to about 60 degree, being larger than that.

In case of the oblique projection method explained in the above, the incidence angle already exceeds 56 degree at the center of the image surface, and the difference in the reflectivity (i.e., the permeability) upon the image surface, for the P polarized light and the S polarized light, comes to be larger than that of the conventional projection type image displaying apparatus. As is shown in FIG. 13, when projecting an image towards a vertical surface or plane, such as, a wall surface 50, by the projection type image displaying apparatus 20, which is disposed horizontally on a table 40, since a regular reflection light (L3) of the image lights having a large incidence angle is reflected towards a ceiling 60, therefore no observer observes that reflection light. The image lights (L1 and L2) to be observed by the observer, who is nearly facing the image surface, opposite, are the lights which are irregularly reflected on the wall surface 50, and the observer can observe the red, green and blue lights under non-polarization condition thereof, therefore such difference is not generated in the reflectivity for each of the colors, nor the color shading is observed.

However, as is shown in FIG. 14, where the image is projected upon the surface of the table 40 by using the projection type image displaying apparatus 20, which is disposed vertically on the table 40, the observer can see the regular reflection light (L3) of the image lights having the large incidence angle, and the reflectivity becomes large for the green color S polarized light on the image surface 30; therefore, there can be observed the image lights, in which the color shading is generated on the green color.

According to the present invention, by taking the situation mentioned above into the consideration thereof, it is an object to provide a projection type image displaying apparatus, with which the color shading is unremarkable, even when projecting the image on the horizontal surface or plane, such as, a table, etc.

For accomplishing the object mentioned above, according to the present invention, there is provided a projection type image displaying apparatus, comprising: a light source unit; an illumination optic system including a color separation means therein; a plural number of image display elements; a cross prism, which is configured to function as a color composing means; and a projection optic system, and further comprising: a structure, which is configured to dispose said projection type image displaying apparatus standing vertically, so as to enable it to display an image on a horizontal surface, wherein a polarized light converting means is provided between said cross prism and said projection optic system, or within said projection optic system.

With applying such structures mentioned above therein, since it is possible to suppress generation of the color shading due to the difference in the reflectivity on the image surface, between the P polarized light and the S polarized light, and therefore there can be provided the projection type image displaying apparatus for enabling to project an image on a horizontal surface or plane, such as, a table, etc., for example.

According to the present invention, it is possible to provided a projection type image displaying apparatus for achieving an improvement in characteristics or performances thereof, comparing to those of the conventional one.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIGS. 1(A) to 1(C) are views for showing an example of the basic structures of a projection optic system of projection type image displaying apparatus, according to an embodiment of the present invention;

FIG. 2 is the entire structure view of the present embodiment of the present invention, in particular, in an image display on the horizontal surface;

FIGS. 3(A) and 3(B) are view for explaining the functions of a polarized light converting means;

FIG. 4 is a view for explaining incidence angles upon an image surface;

FIG. 5 is a view for explaining the polarizing characteristics of reflectivity upon a non-translucent medium;

FIG. 6 is a view for explaining an incidence angle on a reflection mirror;

FIGS. 7(A) and 7(B) are views for showing optic models, differing from each other in the curvature radius thereof;

FIGS. 8(A) and 8(B) are views for showing the difference, in particular, in diffusing power for a reflection light beam;

FIG. 9 is a view for showing a relationship between an incidence plane and P polarized light/S polarized light;

FIG. 10 is a view for showing the structures of an illumination optic system;

FIG. 11 is a view for explaining the polarization characteristic of reflectivity upon a translucent medium;

FIGS. 12(A) to 12(C) are views for explaining the polarization condition in the conventional art;

FIG. 13 is a view for explaining color shading on an image display on a vertical plane; and

FIG. 14 is a view for explaining color shading on an image display on a vertical plane.

### DETAILED DESCRIPTION OF THE PREFERRED EMBODIMENTS

Hereinafter, embodiments according to the present invention will be fully explained by referring to the attached drawings.

### Embodiment 1

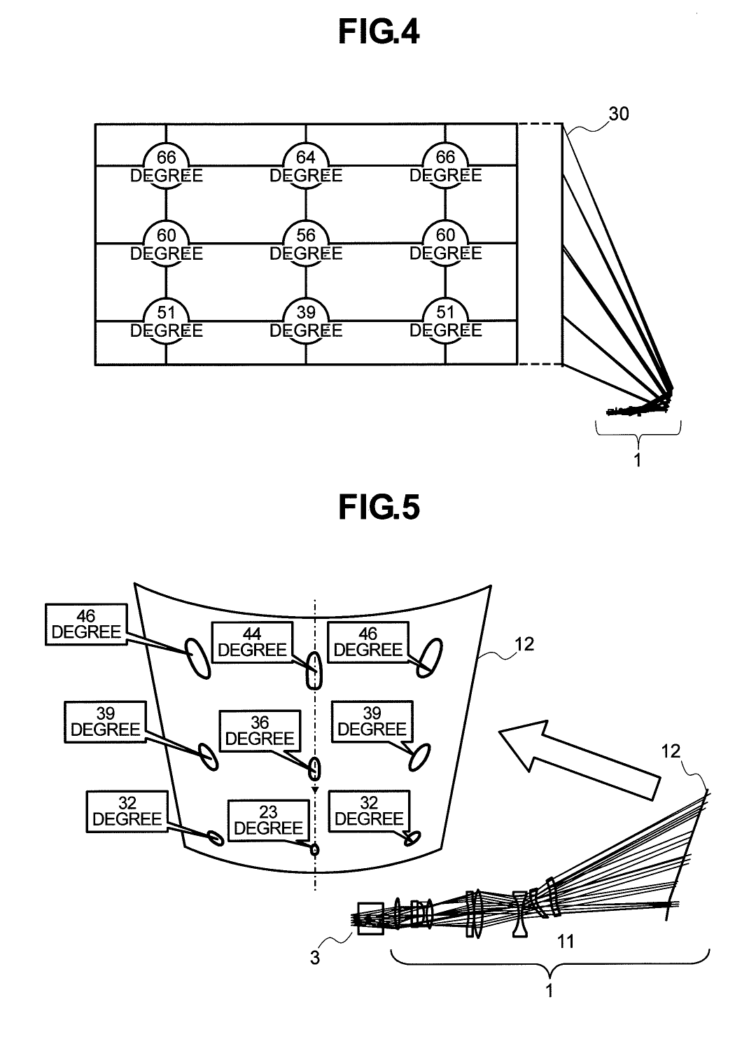

First of all, calculation results are shown in FIGS. 4 and 5, upon incident angels onto a mirror 12 of projection system and incidence angles onto an image surface 30, within a projection optic system projecting an image on a horizontal surface or plane, such as, a table, etc., according to an embodiment of the present invention. In those FIGS. 4 and 5 are shown the incident angels of main light rays, each of which reaches at a central position of one of nine (9) pieces of areas, respectively, obtained by dividing a rectangular image area into, on an image surface 30.

The incidence angle at a representative point for one of the area which are divided into nine (9) on the mirror 12 of projection system shown in FIG. 4 has a value from 23 degree to 46 degree, and it can be seen that it has no material or great difference from the incidence angle on the conventional optical path bending mirror, which is disposed at an angle of 45 degree to an optical path. On the other hand, it can be seen that the incidence angle at the representative point on the image surface 30, which are divided into nine (9), has a value from 39 degree to 66 degree, being greater than 45 degree. The incidence angle on the image surface 30 as a whole thereof comes to be a value of 70 degree or a little bit less than that, at the diagonal positions of the image surface (i.e., at a corner near to 66 degree in FIG. 4).

Then, first of all, calculation is executed on the reflectivity upon a translucent medium, for the purpose of confirmation on the refection characteristics due to difference of the incidence angle for P polarized light and S polarized light. With applying a complex index of refraction n+ki for a non-translucent medium, the reflectivity for the P polarized light and the reflectivity of the S polarized light can be determined by the following equation 2, with using auxiliary numbers “a” and “b” defined in the following equation 3:

R_{S}={(a−cos Φ)²+b²}/{a+cos Φ)²+b²}

R_{P}=R_{S}·{(a−sin Φ tan Φ)²+b²}/{a+sin Φ tan Φ)²+b²} (Eq. 2)

a²={√((n²−k²−sin² Φ)²+4(nk)²}/2+(n²−k²−sin² Φ)²

b²={√((n²−k²−sin² Φ)²+4(nk)²}/2−(n²−k²−sin² Φ)² (Eq. 3)

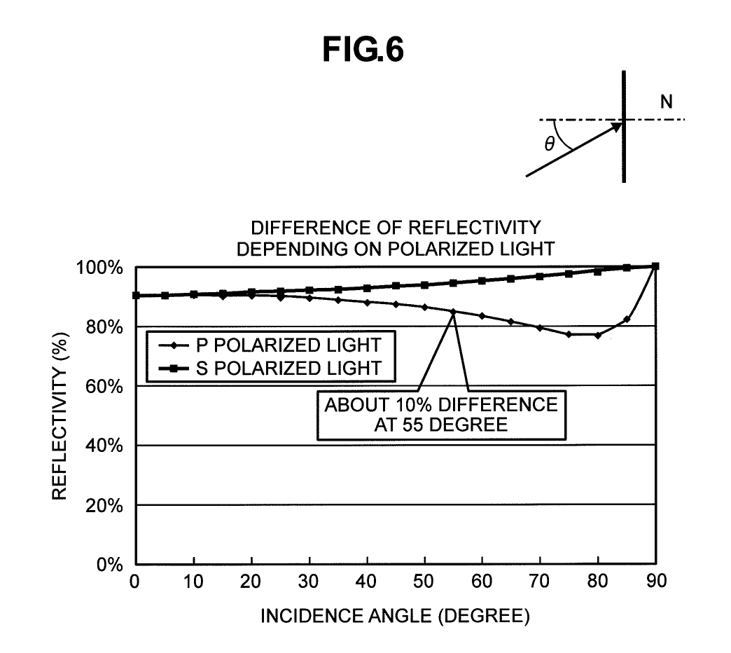

For instance, a calculation result is shown in FIG. 6, with using complex index of refraction 0.65+5i of aluminum (see, a basic physical property chart of KYORITU publication).

In case where the incidence angle is 45 degree, the difference between the S polarized light and the P polarized light is only 6% in the reflectivity thereof, however in case where the incidence angle is 55 degree, the difference comes to 10%, and further in case where the incidence angle is 70 degree, the difference comes up to 18%, i.e., exceeding the difference of reflectivity in the Patent Document 2, therefore, it can be seen that the color shading is generated only due to the difference between the S polarized light and the P polarized light in the reflectivity thereof.

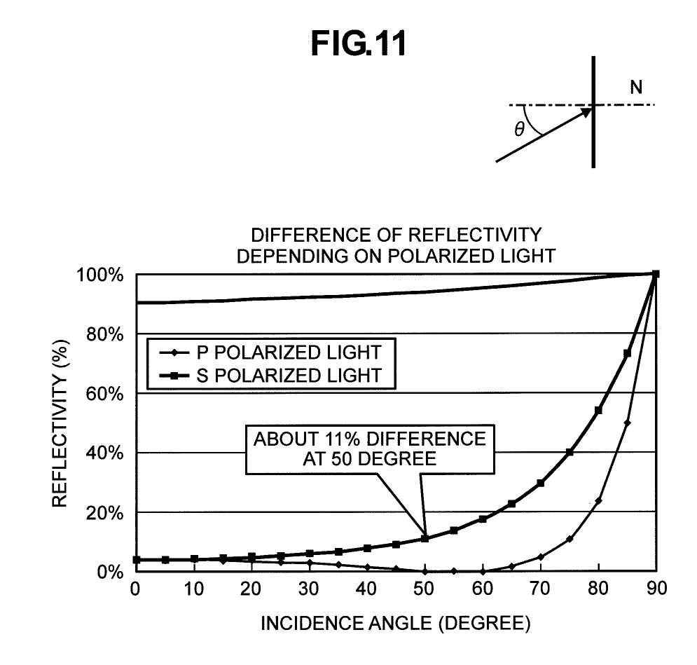

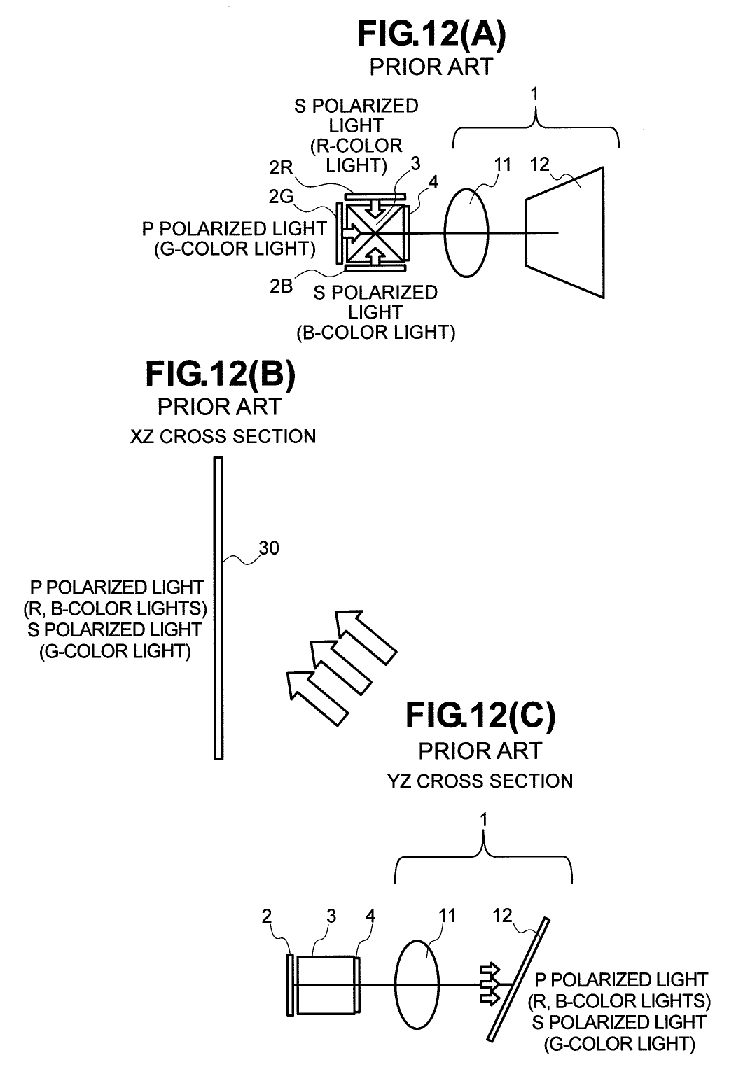

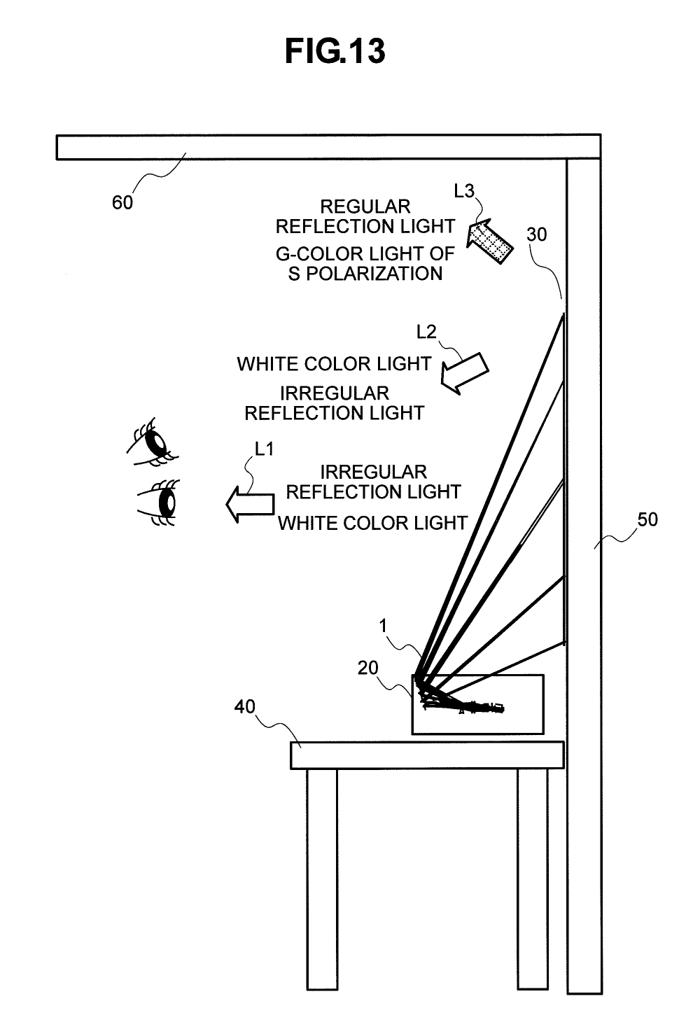

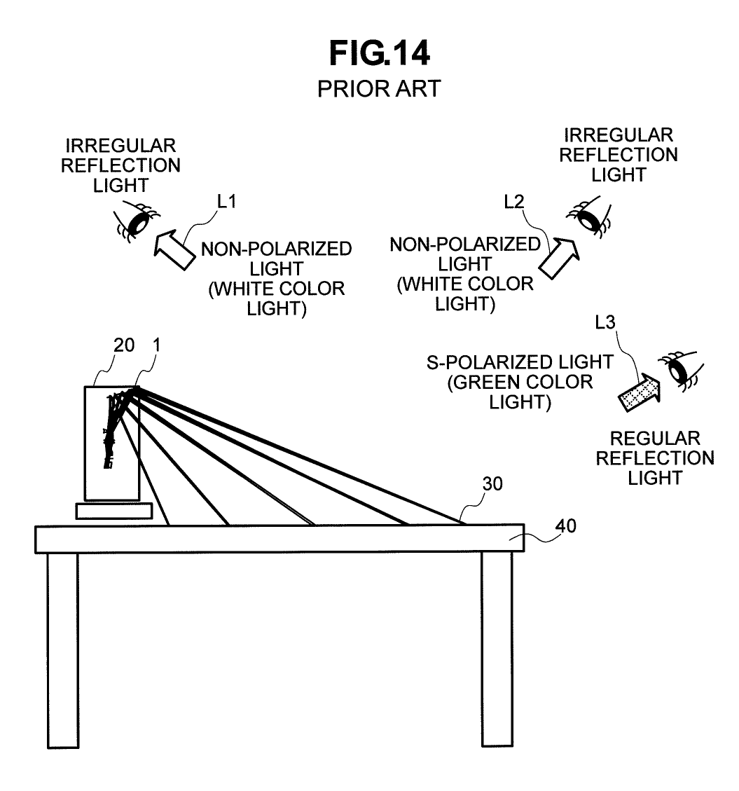

In FIG. 6, although it is the reflectivity on the aluminum, regarding the reflectivity on the translucent medium shown in FIG. 11, which was explained previously, the difference between the S polarized light and the P polarized light comes up to 26% in the reflectivity thereof, and it can be seen that a large difference is generated at a large incidence angle of 70 degree, even if the value changes due to difference of the medium, etc.

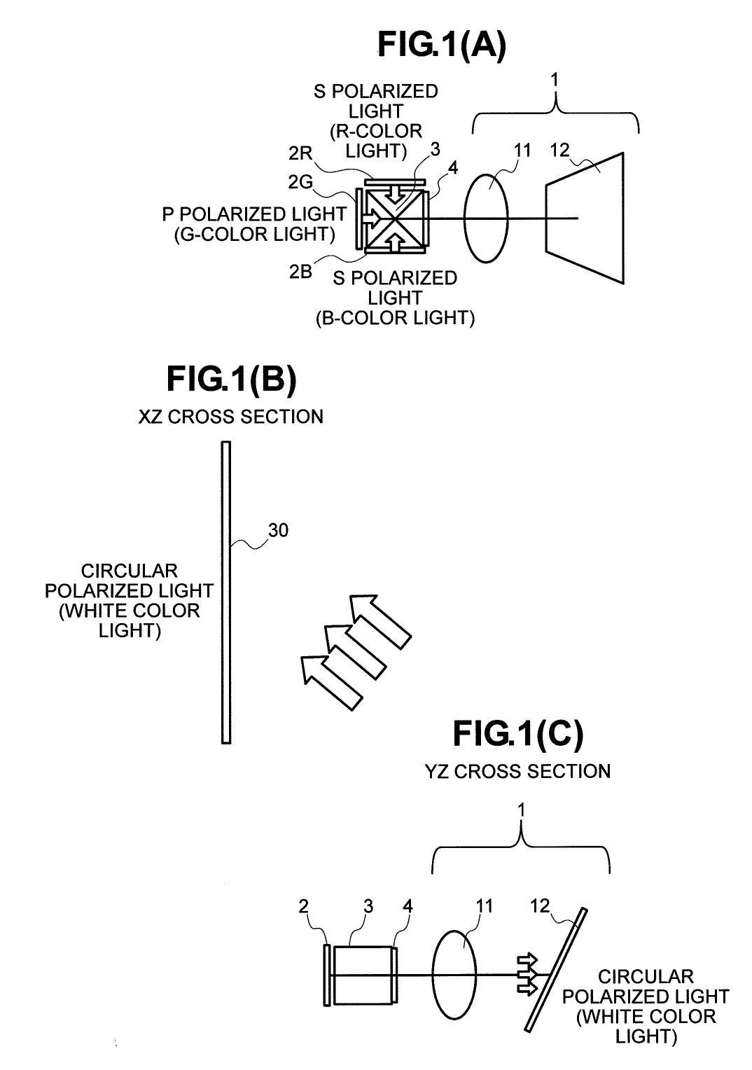

Next, explanation will be made on the detailed structures and the functions, in particular, according to the embodiment of the present invention, by referring to FIGS. 1(A) to 3(B).

First of all, FIGS. 1(A) to 1(C), FIG. 2 and FIG. 3(A) are for explaining the principle portions, according to the embodiment 1 of the present invention.

FIGS. 1(A) to 1(C) are basic structural views for explaining the polarization conditions from the image display element 2 to the image surface 30, omitting an illumination or lighting optic system therefrom, which will be mentioned later. An image light penetrating or passing through each of the image display elements 2R, 2G and 2B for each color is color composed within a cross prism 3, and thereafter it is enlargedly projected on the image surface 30 through the projection optic system 1, which is built up with a refraction lens 11 and a projection mirror 12. FIG. 1(B) shows a XZ cross-section view, and FIG. 1(C) shows a YZ cross-section view, respectively.

As was mentioned above, since G-color light passing through the image display element 2G for G-color light also passes through the cross prism 3 functioning as a color composing or synthesizing means, it is preferable that the G-color light is a P polarized light for the cross prism 3. Since R-color light passing through the image display element 2R for R-color light and B-color light passing through the image display element 2B for B-color light are reflected upon the cross prism 3, it is preferable that the R-color light and the B-color light are S polarized lights for the cross prism 3. However, the P polarized light for the cross prism 3 comes to be the S polarized light, for the projection mirror 12 and the image surface 30.

In such structures, with disposing a ¼ wavelength plate, as a polarized light converting means, on an emission surface of the cross prism 3, it is possible to project the G-color light of the P polarized light and the R-color light and the B color light of the S polarized light, respectively, upon the image surface 30, as circular polarized lights.

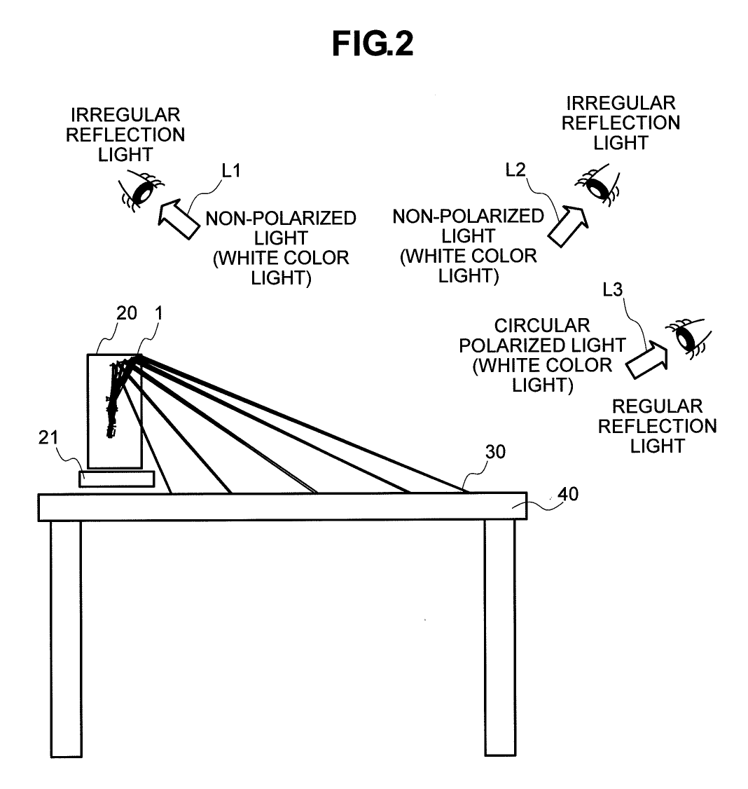

FIG. 2 is the basic structural view of this projection type image displaying apparatus 20, which is disposed through a structure 21, standing vertically, in particular, when projecting the image surface 30 on the horizontal surface, such as, a table, for example. However, the structure 21 may be formed as a unit with the projection type image displaying apparatus 20, or may be attached as a separate part.

Since L1 becomes the irregular reflection light, no color shading is generated, at al, due to the polarization condition of each color light. In L2 is the regular reflection light, in addition to the irregular reflection light, however, since the incidence angle thereof is small, no color shading is generated even when the polarization condition of each color light differs. Lastly, since L3 contains much components of the irregular reflection light, then the color shading is generated due to the difference in the reflectivity on the image surface 30 if the polarization condition differs from for each color light, however because of disposition of the ¼ wavelength plate as the polarized light converting means 4 on the emission surface of the cross prism 3, almost of the each color light is circular polarized therewith, and mostly no difference is in the reflectivity due to the incidence angles of R-color light, G-color light and B-color light, therefore no color shading is generated for the reflection light L3, too.

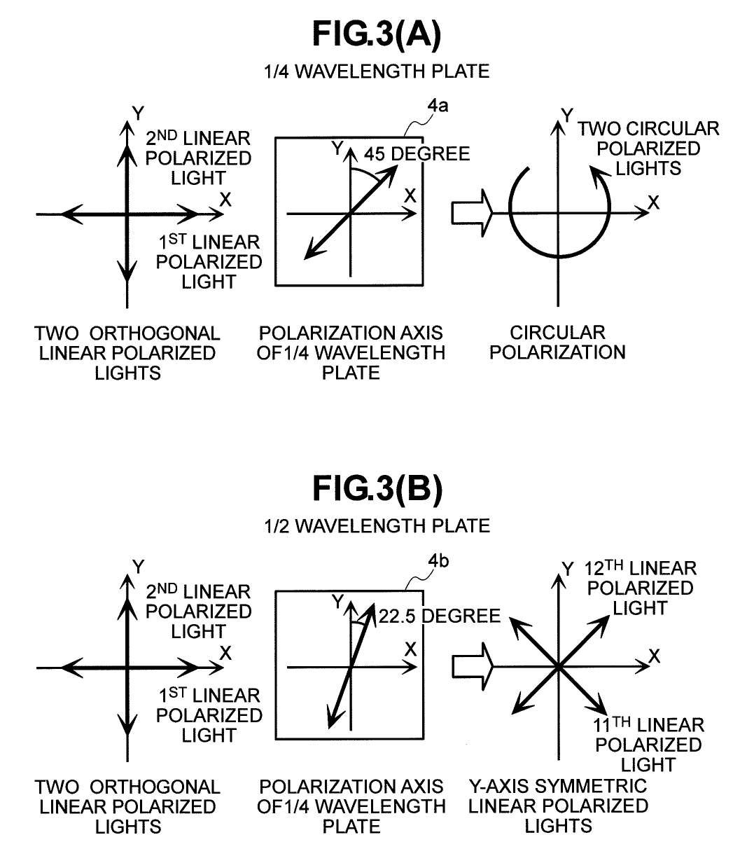

Next, explanation will be made on the details of functions of the polarized light conversion for the each color light, by referring to FIG. 3(A). This FIG. 3(A) shows the manner of circular polarization of a first polarized light and a second polarized light, due to disposition of the ¼ wavelength plate, having a polarization axis in the direction of 45 degree oblique to each of the polarization axes of the first polarized light emitting from the cross prism 3 and the second polarized light perpendicular to that (i.e., the P polarized light and the S polarized light). Strictly or exactly saying, though the circular polarized light, which is converted from the first linear polarized light, differs from the circular polarized light, which is converted from the second linear polarized light, in the direction of rotation thereof, but the reflectivity for each of the color lights is equal on the image surface 30.

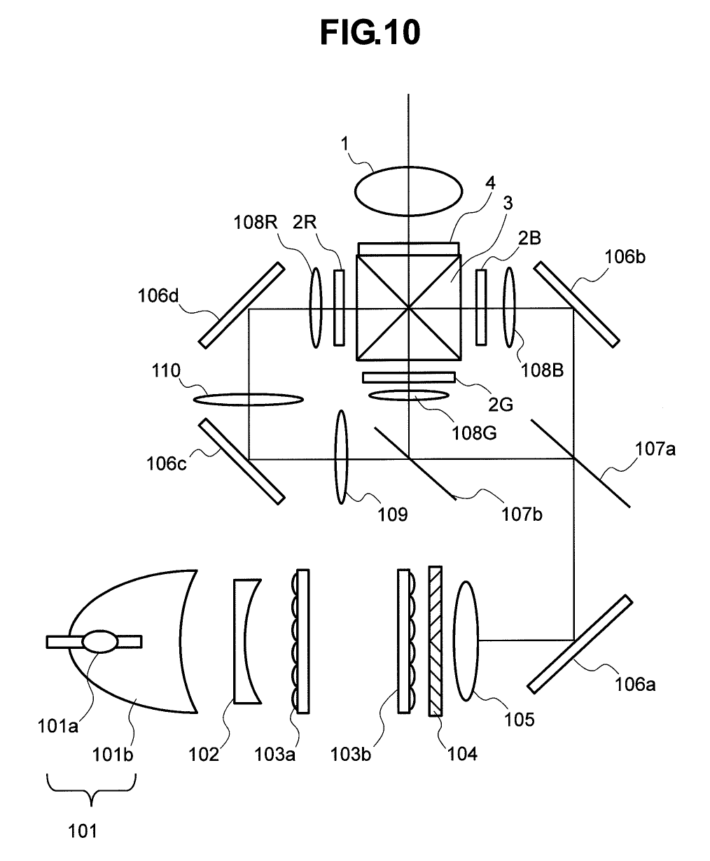

Further, explanation will be given on an illumination optic system for illuminating or lighting the image display elements 2R, 2G and 2B mentioned above, by referring to FIG. 10. In this FIG. 10, a light source unit 101 is made up with a light tube 101a, as a light emitting portion, and a reflector 101b, as a reflecting surface thereof. Flux of lights emitting from the light tube 101a, which is disposed at a first focus position of the reflector having an ellipse-like configuration, are so reflected that the lights are condensed at a second focus position of the reflector 101b. The flux of lights, condensed to be small in the flux size thereof, are converted into a parallel flux of lights by a concave lens 102 having collimating function. However, in case where the reflector 101b is in a parabolic surface configuration, there is no necessity of the concave lens 102 for achieving the collimating function.

The parallel light flux emitting from the concave lens 102 is divided into partial light fluxes by each of cell lenses of a first multi-lens array 103a, so as to be condensed on each of cell lenses of a second multi-lens array 103b corresponding to the first multi-lens array. Each partial light flux condensed is divided into two (2) linear polarized lights, being perpendicular to each other in the vibration direction, once, by means of a linear polarizing means 104, and then the vibration direction of one of the linear polarized lights is changed fitting to the vibration direction of the other, and thereby, being converted into the light being linearly polarized in one direction, in the vibration directing thereof. Each of the partial light fluxes emitting from the linear polarizing means 104 is irradiated on each of the image display elements 2R, 2G and 2B for each light, respectively, through an overlay lens 105. However, between the overlay lens 105 and each of the image display elements 2R, 2G and 2B are disposed the followings: reflection mirrors 106a, 106b, 106c and 106d for bending the optical path, dichroic mirrors 107a and 107b as a color separation optical means, and collimator lenses 108R, 108G and 108B, for collimating the main light ray of projection light flux, in front of the image display elements 2R, 2G and 2B, respectively. On the optical path of the red color light, different in length of the optical path, there are disposed relay lenses 109 and 110, for mapping the overlaid light fluxes at the position of the image display element 2R for the red color light.

### Embodiment 2

Next, explanation will be given about a second embodiment of the present invention, by referring to FIGS. 1(A) to 1(C), FIG. 2 and FIG. 3(B). The difference from the embodiment 1 lies in that, a ½ wavelength plate, in the place of the ¼ wavelength plate, is disposed on the light emission surface of the cross prism 3, as the polarized light converting means 4.

In light beams shown in FIG. 2, though each of the color lights transmitting through the polarized light converting means 4 is the circular polarized light in the embodiment 1; however this embodiment 2 differs from in an aspect that each color light is in one of two (2) kinds of linear polarized lights, i.e., being oblique by 45 degree and −45 degree in the vibration direction thereof.

Thus, the linear polarized light oblique by 45 degree in the vibration direction, with respect to the incident surface, which can be defined by a normal line on the image surface 30 and a plane including that incident light beam therein, can be divided into two (2) vector components, i.e., the P polarized light and the S polarized light. In the similar manner, with the linear polarized light being oblique by −45 degree in the vibration direction thereof, it can be also divided into two (2) vector components, i.e., the S polarized light and the P polarized light. Accordingly, as a result thereof, the polarization condition is equal to each color light.

Next, explanation will be made in details thereof, in particular, the functions of the polarized light conversion for each color light, by referring to FIG. 3(B). This FIG. 3(B) shows the manner of converting the first linear polarized light into an eleventh (11^{th}) linear polarized light rotating the vibration axis thereof by 135 degree, with disposition of the ½ wavelength plate having the polarization axis in the direction oblique by 67.5 degree to the first linear polarized light, for the first linear polarized light emitting from the cross prism 3 and the second linear polarized light perpendicular thereto (i.e., the P polarized light and the S polarized light). This positional relationship means that the ½ wavelength plate has the polarization axis in the direction of 22.5 degree, for the second polarized, and therefore, the second linear polarized light is converted into a twelfth (12^{th}) linear polarized light rotating the vibration axis thereof by 45 degree.

The structures of the illumination optic system from the light source unit 101 up to each of the image display elements 2R, 2G and 2B are same to those in the embodiment 1 mentioned above, and therefore explanation thereof will be omitted herein.

### Embodiment 3

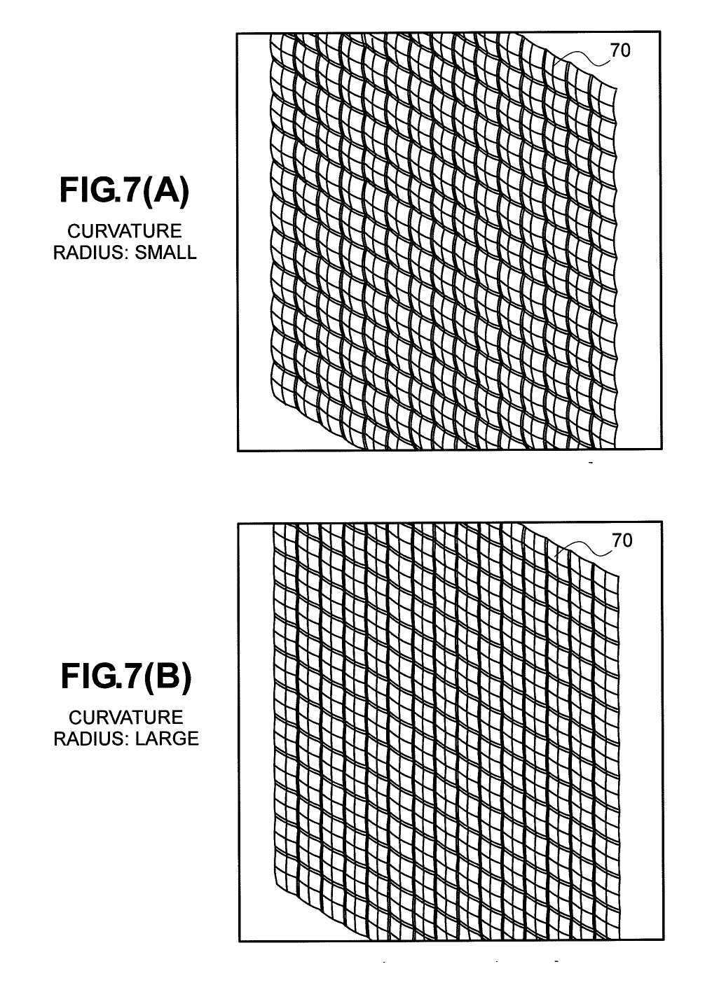

Explanation will be made on an embodiment 3 of the present invention, by referring to FIGS. 7(A) to 9.

The explanation was given in the above, that the color shading is generated by the reason of difference in the reflectivity due to difference in the polarization condition, when projecting each of the color lights on the image surface 30, under the condition differing from each other for the P polarized light and the S polarized light. However, with respect to the polarization condition, it is possible to convert the polarization condition for each color light into a non-polarized condition, as a result thereof, by bringing the surface of the image surface 30 finely concave/convex (or roughened) one.

FIGS. 7(A) and 7(B) are perspective views for showing optic models, each disposing convex lenses in a two-dimensional array manner on a front surface of the image surface 30, aligning them, respectively; i.e., an optic model being small in the curvature radius of each convex lens and an optic model being large in the curvature radius thereof.

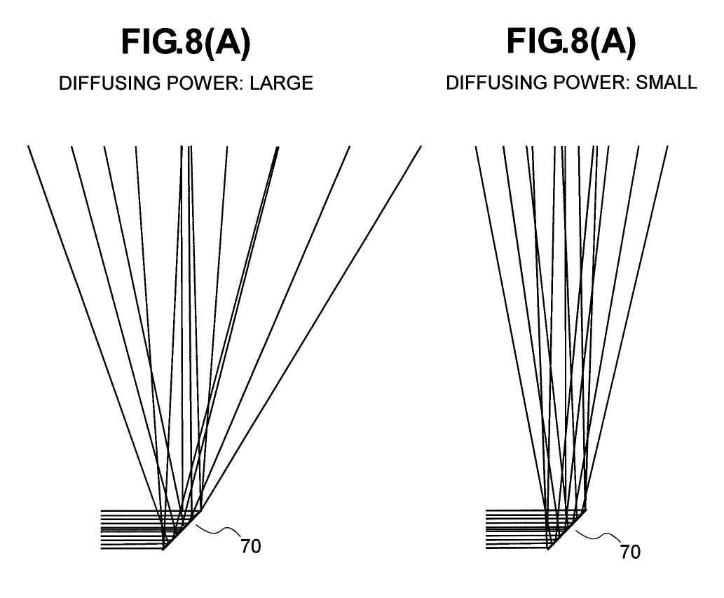

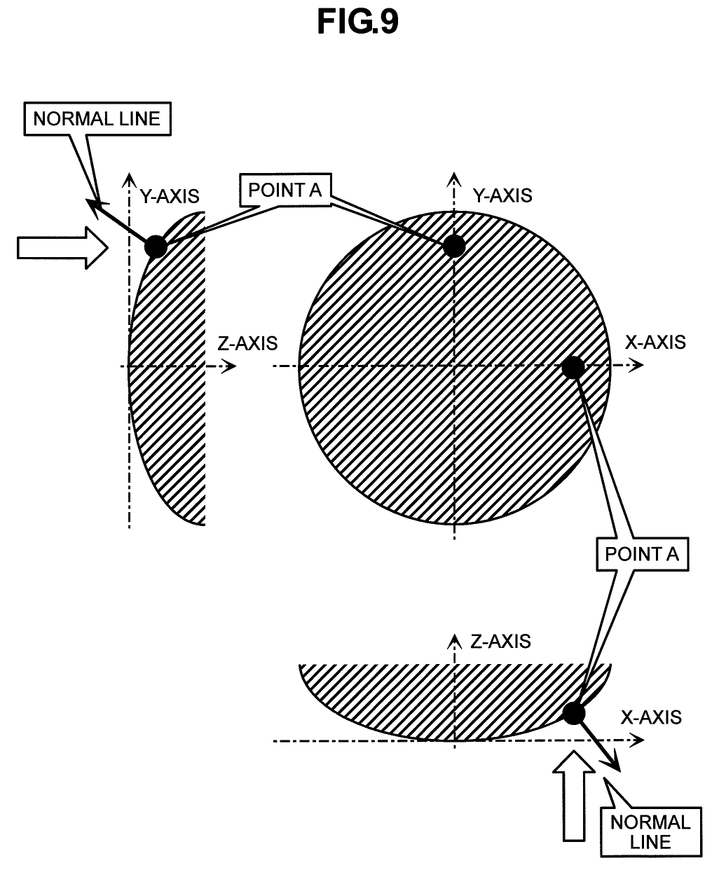

FIGS. 8(A) and 8(B) are views for showing widening of a reflection light flux, upon each of the optic models shown in FIGS. 7(A) and 7(B), when a parallel light flux is incident thereon, and it can seen from them that a diffusing power is large on the optic model having a small curvature radius while the diffusing power is small on the optic model having a large curvature radius.

Next, explanation will be made on the details of function of the non-polarization, by referring to FIG. 9. In case where upon a convex lens is incident a light flux, being parallel with the optical axis of that convex lens, for the light beam incident upon the convex lens at a point “A” thereon, an incidence plane including a normal line thereof is a YZ plane. On the other hand, for the light beam incident upon the convex lens at a point “B” thereon, the incidence plane including a normal line thereof is an XZ plane. Since those two (2) incidence planes are in the positional relationship, they are perpendicular to each other, then the P polarized light at the point “A” comes into the S polarized light at the point “B”, while on the contrary thereto, the S polarized light at the point “A” comes into the P polarized light at the point “B”, even when the same parallel light beams are incident thereupon. Accordingly, with disposing a large number of such convex lenses, each having a very small configuration thereof, on the image surface 30, it is possible to reflect an image light on the image surface 30, under the non-polarization condition (i.e., irregular reflection) as a result thereof.

With those embodiments mentioned above, it is possible to provide the projection type image displaying apparatus, generating no color shading even when projecting the image upon the horizontal surface, by changing the polarization condition for each color light emitting from the cross prism, by means of the polarized light converting means, into that equal to one another as a result thereof, in particular, within the projection type image displaying apparatus, wherein the incidence angle upon the image surface is large.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. A projection type image displaying apparatus, comprising:
a light source unit;
an illumination optic system including a color separation means therein;
a plural number of image display elements;
a cross prism, which is configured to function as a color composing means; and
a projection optic system, in which an incidence angle onto an image surface is equal to 55 degree or greater than that, and further comprising:
a structure, which is configured to dispose said projection type image displaying apparatus standing vertically, so as to enable it to display an image on a horizontal surface, wherein
a polarized light converting means is provided between said cross prism and said projection optic system, or within said projection optic system.

2. A projection type image displaying apparatus, comprising:
a light source unit;
an illumination optic system including a color separation means therein;
a plural number of image display elements;
a cross prism, which is configured to function as a color composing means; and
a projection optic system having a refraction lens and a projection mirror therein, in which an incidence angle onto an image surface of a main light beam reaching at a center of that image surface is larger than an incidence angle on said projection mirror, and further comprising:
a structure, which is configured to dispose said projection type image displaying apparatus standing vertically, so as to enable it to display an image on a horizontal surface, wherein
a polarized light converting means is provided between said cross prism and said projection optic system, or within said projection optic system.

3. The projection type image displaying apparatus, as described in the claim 1, wherein a diffusing power on said projection mirror is larger than a diffusing power on said image surface.

4. The projection type image displaying apparatus, as described in the claim 3, wherein the diffusion power is determined by measuring a size of widening of a reflection light beam while a parallel light flux, corresponding to the main light beam reaching at the center on said image surface, is incident upon said projection mirror.

5. A projection type image displaying apparatus, comprising:
a light source unit;
an illumination optic system including a color separation means therein;
a plural number of image display elements;
a cross prism, which is configured to function as a color composing means; and
a projection optic system, and further comprising:
a structure, which is configured to dispose said projection type image displaying apparatus standing vertically, so as to enable it to display an image on a horizontal surface, wherein
a polarized light converting means is provided between said cross prism and said projection optic system, or within said projection optic system.
